(19) United States
(12) Patent Application Publication
(10) Pub. No.: US 2018/0033086 A1
(43) Pub. Date: Feb. 1, 2018

(54) Annuity brokerage platform

(71) Applicant: Daniel W. Norris, Philadelphia, PA (US)

(72) Inventor: Daniel W. Norris, Philadelphia, PA (US)

(21) Appl. No.: 15/330,038

(22) Filed: Jul. 29, 2016

(51) Int. Cl. G06Q 40/06; G06Q 40/08

(52) U.S. Cl. CPC G06Q 40/06; G06Q 40/08

(57) ABSTRACT

A system and method for facilitating annuity transactions between annuity purchasers and providers via an annuities brokerage platform accessible to the purchasers online. Transactions are processed over the Internet using electronic commerce, commonly known as eCommerce. The sale and purchase transaction is completed electronically and interactively in real-time. Multiple annuities from multiple providers are presented to the purchaser for comparison. Annuity prices are quoted as the minimum premium amount required for Qualified and Non-Qualified purchasers. Upon selecting and ordering their desired annuity product, an application kit is immediately shipped to the buyer upon receipt of the order. Purchasers receive a conditional receipt until the returned application is approved by the provider. Purchasers also have the option to mail premium payment in with the completed application. Application approval is determined by the annuity provider.

### BACKGROUND

Annuities were designed to be a reliable means of securing a steady cash flow for an individual during their retirement years and to alleviate fears of longevity risk, or outliving one's assets. Annuities typically serve the useful function of providing economic protection against the risk of longevity, in that an annuitant has the option of electing a lifetime retirement income, thereby transferring the risk of outliving one's accumulated assets to an insurer.

Annuities can be structured according to a wide array of details and factors, such as the duration of time that payments from the annuity can be guaranteed to continue. Annuities can be created so that, upon annuitization, payments will continue so long as either the annuitant or their spouse (if survivorship benefit is elected) is alive. Alternatively, annuities can be structured to pay out funds for a fixed amount of time, such as 20 years, regardless of how long the annuitant lives. Furthermore, annuities can begin immediately upon deposit of a lump sum, or they can be structured as deferred benefits. Deferred annuities offer their owner the ability to grow and accumulate their savings over time. At a set point in the future, the annuity holder, or annuitant, may begin receiving their payments. These may begin in the form of an income stream with payments received at regular intervals, or the annuitant may opt for one lump sum from the annuity.

Another distinction of the type of annuities available is whether it is classified as a “fixed annuity” or a “variable annuity.” In a fixed annuity, the insurer bears the investment risks. The insurer guarantees a rate of interest applicable to each annuity deposit. The guarantee applies for a specified period of time, often one year, and is then reset periodically, moving in an amount and a direction that correlates with fixed-income investment yields available to the insurer in the capital markets. In a variable annuity, the annuity contract owner bears the investment risk during the accumulation phase of the annuity. The annuitant bears the investment risk during the distribution, or payout, phase of the variable annuity. The person controlling the variable annuity typically has a choice of funds in which they can direct that annuity deposits be invested. These funds typically each represent one asset class, such as large capitalization U.S. common stocks, corporate bonds, money market instruments, or international stocks.

Annuity transactions are required to meet the insurer's suitability requirements. Suitability is a determination that is based upon a customer's particular risk profile, financial situation, securities holdings, investment objectives, and investment experience, that a financial product is appropriate for that customer. This includes all of the annuity's features and benefits such as surrender charges, guaranteed interest rates, bonus interest rates, indexed rate crediting methods, tax-deferred growth, lifetime income riders, annuitization options, nursing home benefits and other living or death benefits. These policy provisions must be provided and understood by the consumer.

A Fiduciary Standard of care is required for brokers that sell annuities. The Fiduciary Standard says that an advisor must work in his client's best interest at all times and provide supporting documentation that he is doing so. The fiduciary standard does not extend to activities, such as order taking where personalized advice is not being offered.

The present invention relates to an online system that is available to annuity buyers worldwide and will have a special portal available to buyers outside of the United States via a QROPS and QNUPS electronic transfer feature. A QROPS (Qualifying Recognized Overseas Pensions Scheme) is a registered scheme that allows pension benefits to transfer overseas. A QNUPS (Qualifying Non-UK Pension Schemes) allows assets held in certain types of overseas pension schemes to be subject to the same tax exemption as UK registered pension schemes. After transferring their pension to a QROPS or QNUPS, buyer's can then purchase an annuity issued by a US insurance company through our platform.

The primary distinction between the present invention and current systems is that the present invention is truly the world's first direct-to-consumer online platform for fixed annuities, immediate and deferred, in that the consumer can complete the entire transaction online without the aid of a licensed insurance agent unless they call the inside sales/customer service team (licensed insurance agents) with questions. Most of the current systems are simply back-end order processing systems for broker use ONLY. Those systems that are for consumer use are merely product proposal and/or performance evaluation systems so that consumers can use to make an informed decision about a particular variable life or annuity product.

Another key distinction is that present invention allows buyers to pay for the annuity online with a credit card or electronic funds transfer (EFT). The sale and purchase transaction is completed electronically and interactively in real-time. Annuity prices are quoted as the minimum premium amount required for Qualified and Non-Qualified purchasers.

### BRIEF SUMMARY OF THE INVENTION

The present invention relates to financial services and products. More particularly, the present invention relates to a method and system for administering the sale of annuity products through electronic commerce, also known as eCommerce. Electronic commerce consists of the buying and selling of products and services via the Internet. It includes business-to-business, business-to-consumer, and consumer-to-consumer transactions. Electronic commerce transactions build consumer trust by limiting the risk of fraudulent activities while ensuring the privacy of consumer information.

### BRIEF DESCRIPTION OF THE DRAWINGS

FIG. 1 illustrates a block diagram of the environment for the usage of the annuities brokerage system, in accordance with one or more implementations.

FIG. 2 illustrates a block diagram of one embodiment of the annuities brokerage system, in accordance with one or more implementations.

FIG. 3 illustrates a screenshot of one embodiment of a login screen within the system client browser of FIG. 1, in accordance with one or more implementations.

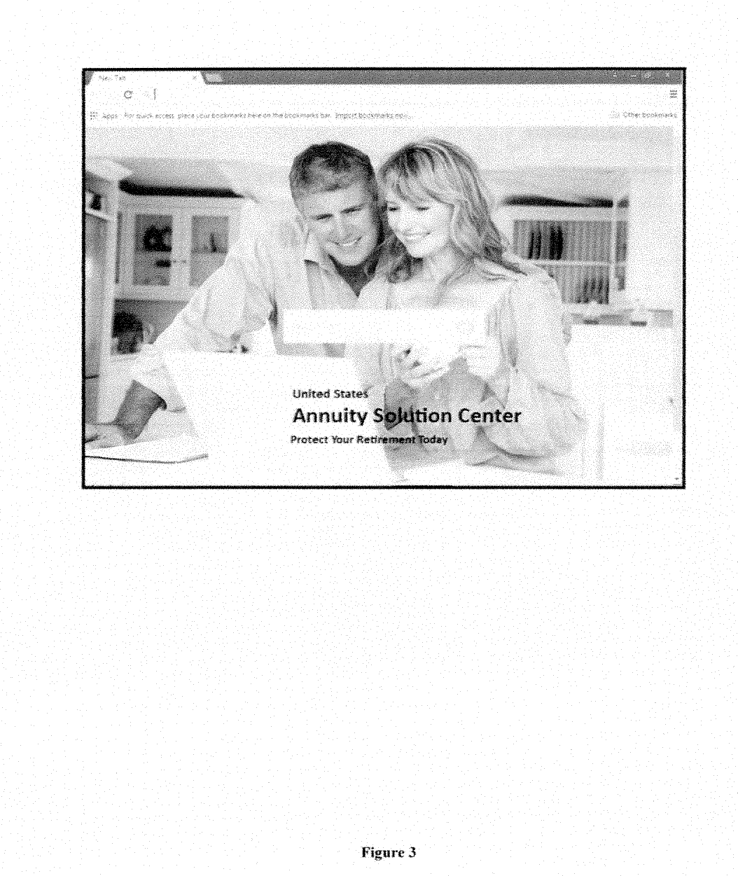

FIG. 4 illustrates a screenshot of one embodiment of a display of multiple annuity offers on the processing system of FIG. 2, in accordance with one or more implementations.

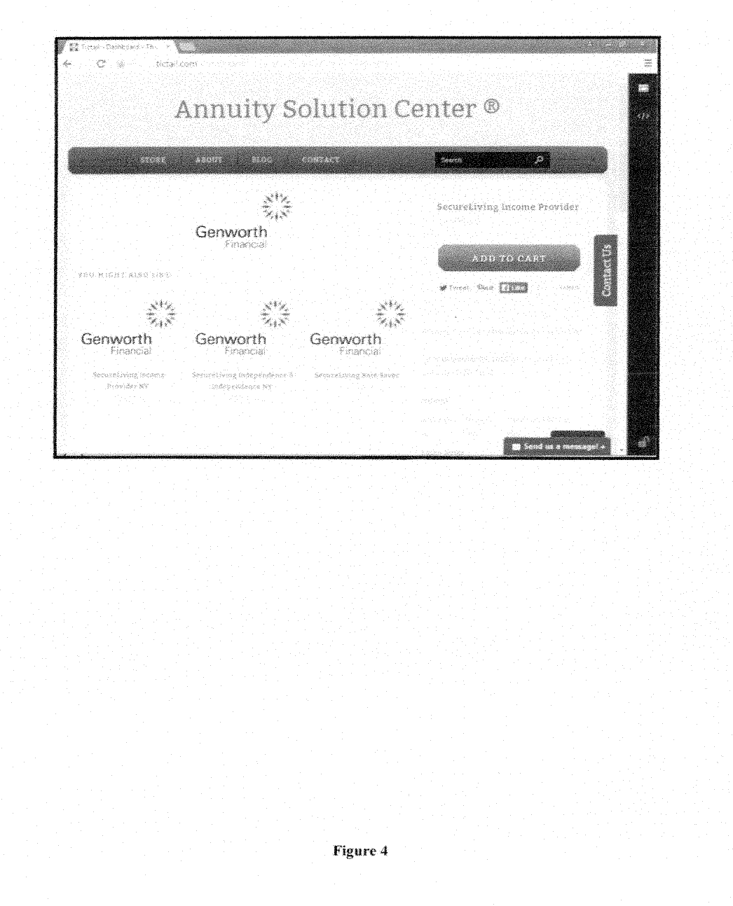

FIG. 5 illustrates a mobile screenshot of one embodiment of a login screen within the system client browser of FIG. 1, in accordance with one or more implementations.

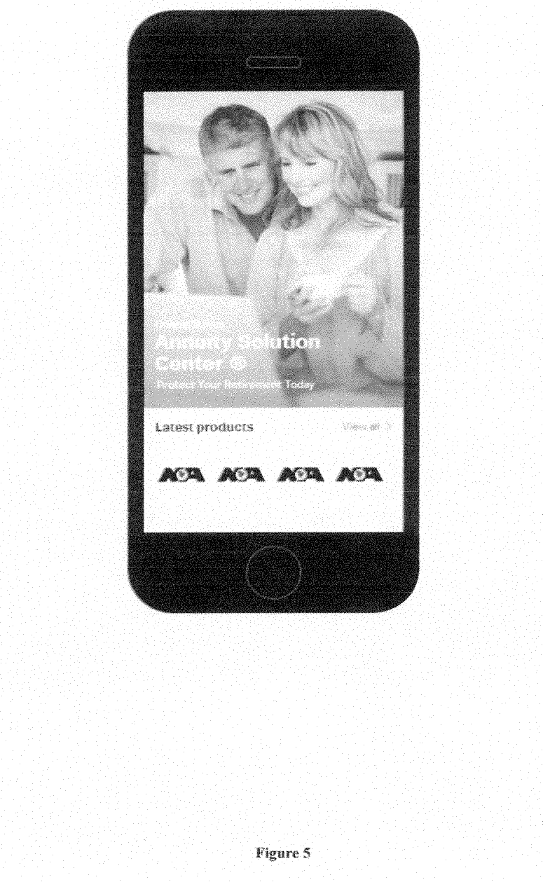

### DETAILED DESCRIPTION AND BEST MODE OF IMPLEMENTATION

The present invention provides an apparatus for obtaining annuity product data from one or more quote vendors. The apparatus comprising an annuity brokerage system for processing a plurality of purchase activity requests related to one or more annuity products. This invention relates to a system for administering the sale of annuity products through an online store or eStore. Scalable, this annuity brokerage system may provide for varying levels of interaction across different jurisdictions.

In the present day, many retirees—or those who are near retirement are discovering that the Internet is a particularly useful tool for managing and tracking their retirement portfolios. Whether it is an individual seeking to occasionally buy or sell stocks, bonds, or other financial instruments; or a licensed broker who manages the financial portfolios of numerous clients; access via the Internet to conduct these transactions is now an important channel for the execution of this business.

The present disclosure relates to a method and system for providing a plurality of annuity products via the Internet and eCommerce. Customers are able to view State-specific product materials and add their order to a shopping cart to complete the transaction. The sale and purchase transaction is completed electronically and interactively in real-time. Some states in the U.S. requires the customer to review and sign one or more State mandated forms in order to purchase annuities. The present invention addresses this requirement by allowing the customer to download and print each required form as a hard copy and sign each by hand. The forms are then returned by regular mail so that the transaction may be consummated. Some carriers allow applications to be taken by phone, thereby requiring a licensed agent to call the buyer on the phone to complete an application.

Multiple annuities from multiple providers are presented to the purchaser for comparison. State-specific product brochures are stored in a repository in Portable Document Format (PDF) substantially identical to brochures as they would appear if presented to the customer as a hard-copy. Annuity products include Fixed Index Annuities (FIA), Single Premium Immediate Annuities (SPIA), Single Premium Deferred Annuities (SPDA), Qualified Longevity Annuity Contracts or QLACs, also known as Deferred-Income Annuities (DIA), Multi-Year Guaranteed Annuities (MYGA), and Variable Annuities (VA).

An annuity calculator is included in the annuities platform to help buyers work out how much money they will need to get their desired monthly retirement income. Annuity prices are quoted as the minimum required premium amount for Qualified and Non-Qualified purchasers. Upon selecting and ordering their desired annuity product, an application packet is immediately shipped to the buyer upon receipt of the order. A conditional receipt (if applicable) and disclosure document is included to meet compliance obligations. Buyers can pay the minimum required premium online using a credit card, or they may opt to send their entire premium in the mail along with their completed application. If they opt to pay the minimum required premium amount online, they can send additional premium directly to the annuity provider after they have been approved. Once approved, an annuity contract is sent directly to the purchaser. Application approval is determined by the annuity provider.

Annuity applications are approved or denied based on the suitability of the applicant. Annuity buyers read a disclosure statement that explains the importance of annuity transaction suitability. Consumers understand that the purchase must be consistent with their risk tolerance, financial objectives, and financial situation. Through the annuity brokerage platform, buyers are able to research and compare each annuity product to make sure that it matches their specific needs. If for any reason an applicant is deemed unsuitable by the insurer, any monies sent to the insurer will be refunded to the buyer in full.

To assist our team with compliance processing (customized workflows and suitability reviews) we will utilize a proprietary compliance and order management solution embedded within the system for back-office processing. This wizard-based solution will streamline the order-entry process and support customized workflows and suitability reviews. All orders will be reviewed by our in-house team to ensure state compliance.

The invention draws on technologies such as mobile commerce, electronic funds transfer, supply chain management, Internet marketing, shopping carts, online transaction processing, electronic data interchange (EDI), inventory management systems, and automated data collection systems. Studies have shown that online shoppers like comparing features and benefits at their leisure, without being pressured by a salesperson. Consumers can review rates and premiums online without calling or visiting a broker's office. However, contact methods such as email, phone or live chat are available options.

The invention provides clients with the ability to perform direct comparisons for all annuity types, filtering important criteria such as rating, class, and risk tolerance so they can determine the most suitable annuity option for them to choose. Our system includes a Process Observer for Built-In Processes (POB) which allows customers to monitor and optimize core processes based on our built-in order process and supports insight to actions. Customizable search features for clients can include contract type, i.e., immediate, deferred, single premium or multiple deposits over time, terms, years until retirement, amount of desired premium payment, etc.

A special portal for foreign clients with QROPS (Qualified Recognized Overseas Pension Scheme) or QNUPS (Qualifying Non-UK Pension Scheme). After transferring their pension to a QROPS or QNUPS, buyer's can then purchase an annuity issued by a US insurance company through our platform.

New content is automatically posted to the portal news feed, ensuring frequent value-touches for each client. Commercial users can add functionality or change the stores appearance without switching themes. Our system includes instant messaging (IM) and chat features for client support.

Users of the annuity brokerage platform includes retirees, near-retirees, investors, attorneys, trustees and other fiduciaries. The annuity brokerage system will be made available to a number of vendor business types including insurance brokers, agents, investment advisors, wealth managers, fund managers, private-sector pensions, private-sector unions, and public sector pensions offered by federal, state and local levels of government. These vendors can license the brokerage platform and offer their services as it relates to annuity products online as an eStore or in their desired user interface. The online system is extremely easy to navigate for both browsing and purchase, and includes a rapid checkout feature. The platform's streamlined back-end order flow system will enable swift order processing. Automatic commission processing through the platform's commission system allows agencies to track and reconcile commission arrangements with their agents.

As described below, the annuity brokerage system, through the utilization of a single processing environment having the ability to perform straight-through processing, commonly referred to as “STP,” provides users looking to buy annuities across a single platform with a secure, timely and cost-effective transaction. The STP model automates much of the annuity buying process, reduces manual intervention, and speeds processing while ensuring data integrity and quality control.

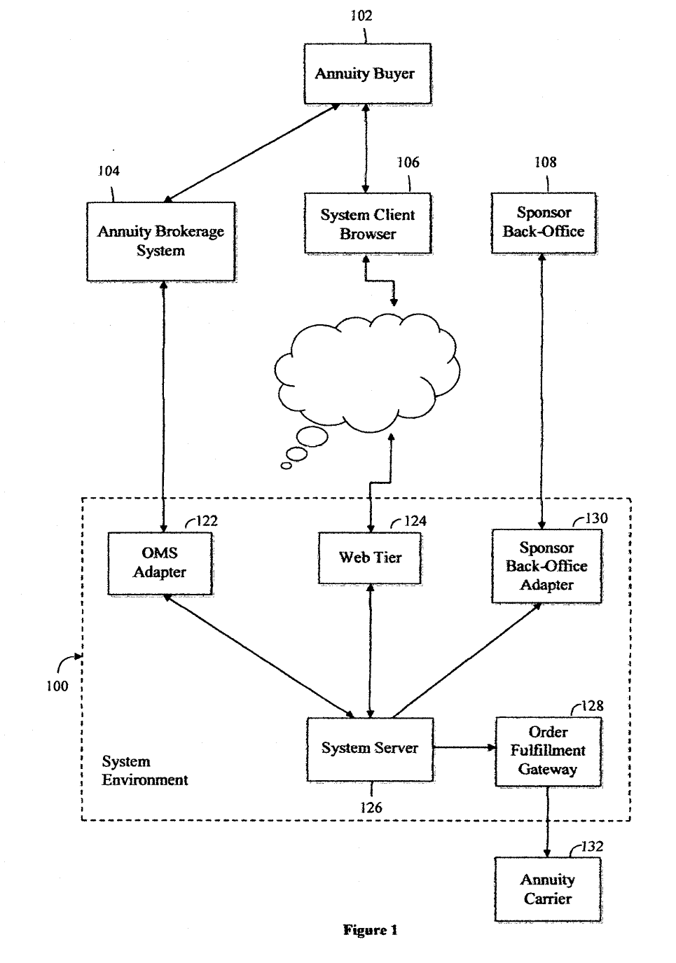

FIG. 1 illustrates a system environment 100 having an annuity buyer 102 that utilizes a computer to access a user interface 106, typically across an internet connection, shown generally at 124. The user interface 106 may be a software module running on a server or other operating platform. The interface 106 may use known security techniques or protocols to provide secure connections there between. In another embodiment, the annuity buyer 102 may have existing accounts and can provide a password or other validation for establishing the secure connection.

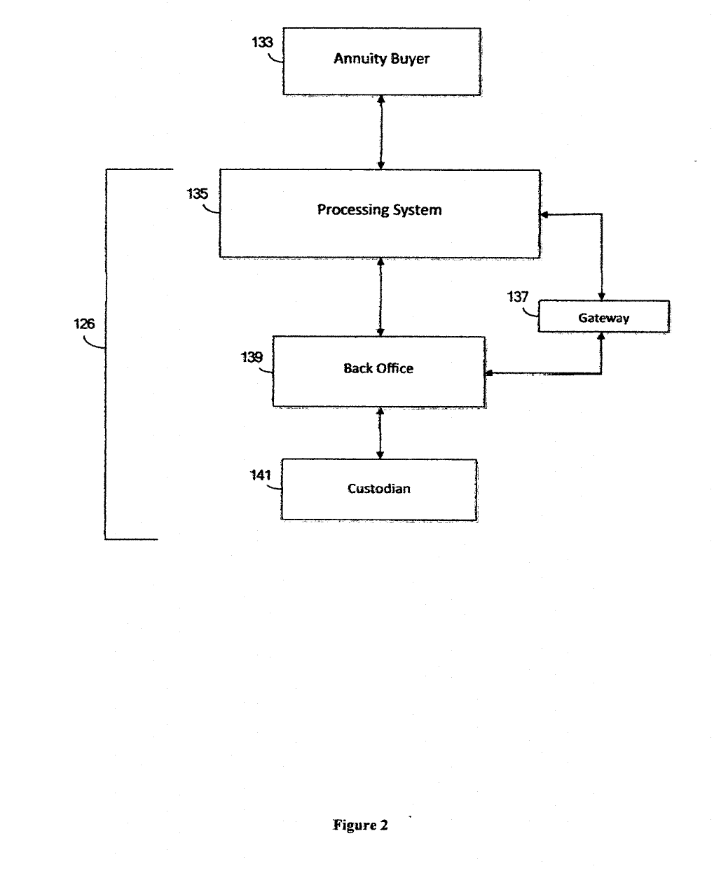

FIG. 2 illustrates one embodiment of an annuity brokerage system. The system includes an annuity buyer interface 133, an exchange processing system 135, a gateway 137, a back office 139 and a custodian 141.

The buyer interface 133 may be a computing interface, similar to the user interface 106 as described with respect to FIG. 1, where an annuity buyer 102 may access the exchange processing system 135. The exchange processing system 135 may be one or more processing systems executing software applications providing for the functionality of a buyer to utilize the exchange system as well as monitor the current status of annuity interest rates, premiums, and product updates. The gateway 137 may be one or more processing devices facilitating communication with a back office 139 or, if and to the extent that the buyer interface may communicate directly with all portions or some of the back office 139, there may be a direct communication between them as is shown. The back office 139, which may include the custodian 141, provides an electronic settlement of purchases and other transactions performed by the exchange processing system 135.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. In view of the teachings of this specification, numerous alternative embodiments could be implemented, using either current technology or technology developed after the filing date of this patent, as may be readily apparent to those of ordinary skill in the art, which would still fall within the scope of the invention, and that the invention is not limited by specific embodiments described herein.

It should be understood that there exist implementations of other variations and modifications of the invention and its various aspects, it is therefore contemplated to cover any and all modifications, variations or equivalents that are apparent in view of the disclosure hereof and fall within the scope of the basic underlying principals disclosed and claimed herein.

We claim:

1. An electronic commerce system for buying annuities, comprising: a plurality of system user interfaces for system users to communicate with an electronic sales platform for purchasing annuities; a communications network for bi-directional communications between the plurality of system user interfaces and the electronic purchasing platform; and the electronic sales platform in bi-directional communications with the plurality of system user interfaces through the communications network.

2. An annuities sales platform comprising a communication interface configured to connect to system client devices; an annuity system server cluster comprising a group of independent network servers that operate and appear to the system client devices as if the independent network servers were a single server computer; and an adaptive transmission controller in communication with the annuity system server cluster that processes content in multiple versions optimized to screen sizes of the client devices; where the annuity system server cluster is configured to respond to native application clients resident to one or more of the client devices and is programmed to execute code stored in a non-transitory media that renders annuity comparison services, and on-line annuity processing services.

3. The annuity platform of claim 1 where the client device executes code stored in the non-transitory media that renders annuity comparison services, and on-line annuity processing services.

4. The annuity platform of claim 2 further comprising a comparison services server comprising a computer programmed to respond to a request from a native annuity shopping client resident to one of the client devices with multiple annuity options presented to a user of one of the client devices.

5. The annuity platform of claim 4 where the native annuity shopping client is executed through a Web browser.

6. The annuity platform of claim 2 further comprising a quoting services server comprising a computer programmed to enable the client devices to render comparisons of different annuity plan options, annuity contract premiums, or annuity carriers on a side-by-side display that is a unitary part of one of the client devices.

7. The annuity platform of claim 1 where the client device executes code stored in the non-transitory media that allows client to complete the sales transaction through the client device.

8. The method of claim 1 further comprising non-US based clients the ability to complete a sales transaction through a special web portal on the primary site available to buyers outside of the United States via a QROPS and QNUPS electronic transfer feature.
